(19) United States
(12) Patent Application Publication
(10) Pub. No.: US 2020/0060291 A1
(43) Pub. Date: Feb. 27, 2020

(54) METHOD FOR OPERATING A DOUGH-KNEADING DEVICE AND KNEADING DEVICE

(71) Applicant: WP Kemper GmbH, Rietberg (DE)

(72) Inventors: Christopher Jander, Rheda-Wiedenbrück (DE); Felix Oestersötebier, Gütersloh (DE)

(73) Assignee: WP Kemper GmbH, Rietberg (DE)

(21) Appl. No.: 16/546,812

(22) Filed: Aug. 21, 2019

(30) Foreign Application Priority Data
Aug. 23, 2018 (DE) 10 2018 214 278.5

(51) Int. Cl. A21C 1/14; A21C 1/02

(52) U.S. Cl. CPC A21C 1/1455; A21C 1/146; A21C 1/02

(57) ABSTRACT

When operating a dough-kneading device, a momentary torque acting on kneading tool of the dough-kneading device, a momentary speed and a momentary rotational position of the kneading tool are measured. From the measurement values, a dough elasticity parameter and a dough viscosity parameter are determined as actual dough parameters. Dough-status data is then output based on the measurement data and the determined actual dough parameters. From the measurement values, dough parameters can therefore directly be concluded, which represent a measure on the one hand for the viscosity and, on the other hand, for the elasticity of the dough. An objective monitoring of the kneaded dough is therefore possible. In addition or as an alternative, an expected kneading period until reaching a maximum torque is determined.

### CROSS-REFERENCE TO RELATED APPLICATIONS

This application claims the priority of German Patent Application Serial No. DE 10 2018 214 278.5 filed on Aug. 23, 2018, pursuant to 35 U.S.C. 119(a)-(d), the content of which is incorporated herein by reference in its entirety as if fully set forth herein.

### TECHNICAL FIELD

The disclosure relates to a method for operating a dough-kneading device. Furthermore, the disclosure relates to a dough-kneading device.

### BACKGROUND

A dough-kneading device is, for example, known from DE 10 2010 042 542 A1.

### SUMMARY

A first object of the present disclosure is to further develop a method for operating a dough-kneading device in such a way that, objectively, no undesired dependencies on dough-status data having respective measurement methods can be acquired during operation.

This object is achieved by means of a method for operating a dough-kneading device comprising the following steps: time-resolved measurement of a momentary torque acting on a kneading tool of the dough-kneading device, time-resolved measurement of a momentary speed of the kneading tool, time-resolved measurement of a momentary rotational position of the kneading tool, determining a dough elasticity parameter and a dough viscosity parameter as the actual dough parameters from the measurement values, outputting dough status data based on the measurement data and the determined actual dough parameters.

The industrial dough-kneading process is generally broken down into two phases. First, a heterogeneous mass consisting of raw ingredients, such as water, flour and salt, is mixed at low speeds of the kneading spiral in order to form a homogeneous dough mass. During subsequent kneading, chemical dough structures are formed, and the dough is kneaded into a visco-elastic mass at a higher speed. Here, it is important to achieve the most optimized values as possible, on the one hand, for the elasticity or stiffness and, on the other hand, for the viscosity of the dough. The viscosity initially increases until, after a maximum level has been adhered to, it decreases again in the case of over-kneading. A corresponding progression applies to elasticity. Optimization criteria in the process assessment arise on the one hand due to requirements for product quality and, on the other hand, due to efficiency requirements for the machining process.

The inventors recognized that the dough can be abstracted within the scope of the kneading-period determination, for example, as a spring-damper system mounted on the tub wall, which counteracts the kneading tool with a reaction force. Here, the spring stiffness c_{d}, the elasticity and the damping d_{d} models the viscosity of the dough. Other parameters can be, in addition to the spring stiffness and damping, a radius of the kneading tool and a minimal gap sₘᵢₙ between the tub wall and the tool.

The inventors also recognized that not only the measured kneading-tool torque itself, but also a speed and a rotational position of the kneading tool should be included in an analysis of a kneading-tool-torque measurement result. If the speed and rotational position data are also taken into account, a correspondingly finer analysis of the torque measurement results is possible. An objective monitoring of the kneaded dough during the kneading operation is therefore possible.

By means of a vibration analysis of the time-resolved measurement data, the objective measured dough variables, viscosity and elasticity, are available for a determination. On the basis of the thus objectively determined dough status, the effect of the kneading operation can be determined in a reproducible manner and the dough-kneading device can be controlled accordingly for the production of an optimally kneaded dough. Both a lack of kneading, in which undesirably a viscosity of the dough or an elasticity of the dough is too low, as well as an over-kneading, in which undesirably a viscosity of the dough or an elasticity of the dough have exceeded a maximum, are avoided.

The vibration analysis can be carried out with the help of an extended Kalman filter.

A control of the kneading operation exploits the advantages of determining the actual dough parameters.

When comparing the actual dough parameters with the target dough parameters, the following steps are carried out: determining an actual value of a merit function, with which the actual dough parameters are associated and comparing the actual values of the merit function with a specified target value of the merit function. In the case of an actual value/target value comparison, the actual elasticity values, on the one hand, and the actual viscosity values, on the other hand, can be tracked together along with their target values in a specified manner. In the simplest case, the merit function is a product or a ratio of the dough parameters, elasticity and viscosity. Depending on the merit function, the dough parameters can also be weighted and, in particular, other parameters, such as the dough temperature for example, can also be included. In the sense of a multi-target optimization (multi-criteria optimization), the available variables can be set to achieve an optimal compromise between the competing targets (Pareto optimum) with regard to the specifications. In order to take into account the specific form of the Pareto front, which results depending on the variable parameters or interferences (e.g. environmental conditions), a desired target ratio can be adjusted using a Pareto regulator. Such a Pareto regulator is described in the technical article: Kessler, Jan Henning; Trächtler, Ansgar: Control of Pareto Points for Self-Optimizing Systems with Limited Objective Values. In: The 19th IFAC World Congress, Cape Town, South Africa, 24-29 Aug. 2014.

In particular, as a result of the comparison of the actual values with the target values, in particular, based on the merit function, a tracking of a target progression of a temporal dependency of the speed of the kneading tool can take place.

Another object of the present disclosure is to further develop a method for operating a dough-kneading device in such a way that full kneading of the dough to the furthest extent possible is achieved, thereby simultaneously avoiding, in particular, an undesired over-kneading of the dough.

This object is achieved by means of a method comprising the following steps: time-resolved measurement of a momentary torque acting on a kneading tool of the dough-kneading device, time-resolved measurement of a momentary speed of the kneading tool, time-resolved measurement of a momentary rotational position of the kneading tool, determining an expected kneading period until reaching a maximum torque which, in the event of further operation of the dough-kneading device, acts on the kneading tool, based on the measured torque, the measured speed and the measured rotational position, ending a kneading operation for a currently kneaded batch of dough depending on the determined kneading period.

The time-resolved evaluation of the momentary measurement data allows a correspondingly precise inference to be made regarding an expected kneading period until reaching a maximum torque which, in the event of operation of the dough-kneading device, acts on the kneading tool. Thereby, the point in time can be precisely inferred at which the maximum torque reached and at which the dough is correspondingly kneaded to optimum quality. Based on the thus determined expected time for reaching the maximum torque, it can be decided exactly when the kneading operation is to be ended.

An end to the kneading operation exactly after the expiry of the determined kneading period, leads to the presence of optimally kneaded dough immediately following the end of the kneading operation. The dough is then directly available for further processing.

An end of the kneading operation defined before the expiry of the determined kneading period until reaching the maximum torque offers the possibility to supply the dough, after the kneading period, for further processing, in which the dough still continues to be mechanically stressed so that the dough is kneaded to achieve optimum dough consistency following the kneading period within the dough-kneading device. This end of the kneading operation defined before the end of the determined kneading period thus increases the flexibility of use of the dough-kneading device.

The use of at least two parallel determination algorithms which are included in the determination of the expected kneading period, enables the determination of the expected kneading period, in particular, when using a large parameter bandwidth concerning the composition of the dough and the kneading operational conditions. For example, an average can then be calculated between the results of the various determination algorithms to determine the expected kneading period. Alternatively or in addition thereto, extreme results can be discarded before determining the expected kneading period. Weighted averaging is also possible.

A democratic determination of the expected kneading period by a plurality of the parallel determination algorithms, leads to a high level of robustness of the kneading-period determination. For example, if three independent determination algorithms provide respective kneading period results, wherein two of these results differ only slightly and a third result differs more strongly, only the two results that only slightly differ from each other are taken into consideration for the kneading-period determination.

Determination algorithms for determining the actual dough parameters and/or the expected kneading period using a Kalman filter and for determining the actual dough parameters and/or the expected kneading period using a floating mean value formation have proven to be reliable due to their accuracy and/or robustness.

A temperature measurement included in the determination of the actual dough parameters and/or the expected kneading period, represents a decisive factor for an end of the mixing phase of the dough before kneading and further increases the reliability of the kneading-period determination. A dough level measurement can be included in the determination of the expected kneading period. Furthermore, this can further increase the reliability of a kneading-period determination. A dough temperature and/or a room temperature can be measured and included in the kneading-period determination.

In addition, it has also been recognized that, depending on the determination algorithm used in modelling a temporal dependency of the torque acting on the kneading tool, the dough parameters, stiffness and viscosity, emerge as additional results. These dough data can then be used for further dough processing.

It is a further object of the present disclosure to specify a dough-kneading device, with which, in particular, the operating method described above can be carried out.

This object is achieved by means of a dough-kneading device with a dough container, with a kneading tool rotating within the dough container, with a kneading tool drive, with a torque measuring unit for time-resolved measurement of a momentary torque acting on the kneading tool, with a speed measuring unit for time-resolved measurement of a momentary speed at which the kneading tool rotates, with a rotational position measuring unit for time-resolved measurement of a momentary rotational position of the kneading tool, with an analysis unit connected to the torque measuring unit, the speed measuring unit and the rotational position measuring unit on a signal level for the analysis of torque measurement results of the measuring unit, wherein the analysis unit is connected to the kneading tool drive on a signal level.

In the analysis unit of the dough-kneading device, the determination of the actual dough parameters, that is to say, in particular, the dough elasticity parameter and the dough viscosity parameter and/or the determination of the expected kneading period until reaching a maximum kneading-tool torque can be carried out. Based on the signal connection of the analysis unit to the kneading-tool drive, the analysis unit can control the kneading-tool drive and, in particular, depending on the determined dough status and/or depending on the determined kneading period, it can end the kneading operation for a currently kneaded batch of dough.

Exemplary embodiments of the invention are explained in more detail in the following based on the drawing.

### BRIEF DESCRIPTION OF THE DRAWINGS

FIG. 1 shows an embodiment of a processing device for kneading dough in a partially sectioned of lateral view that partially reveals internal details;

FIG. 2 shows a section of a dough container in the form of a tub together with a kneading tool designed as a spiral with an adjacent wall of the tub of the dough-kneading device;

FIG. 3 shows a section in accordance with Line III-III in FIG. 2, which is more schematic, in turn, in comparison with FIG. 2, wherein additional spacing, angular, force and torque variables are drawn in;

FIG. 4 shows a section of a time progression of a measurement of a momentary torque shown in a schematic diagram that acts on the kneading tool of the dough-kneading device in accordance with FIGS. 1 and 2;

FIG. 5 shows also shown in a diagram, the time progression of a modelled torque adapted to the measurement values in accordance with FIG. 4, which acts on the kneading tool;

FIG. 6 shows a schematic flow chart of a method for operating the dough-kneading device in accordance with FIGS. 1 to 3; and

FIG. 7 shows a very schematic diagram showing a typical smooth progression of the torque acting on the kneading tool during a kneading period until reaching a maximum torque level.

### DETAILED DESCRIPTION

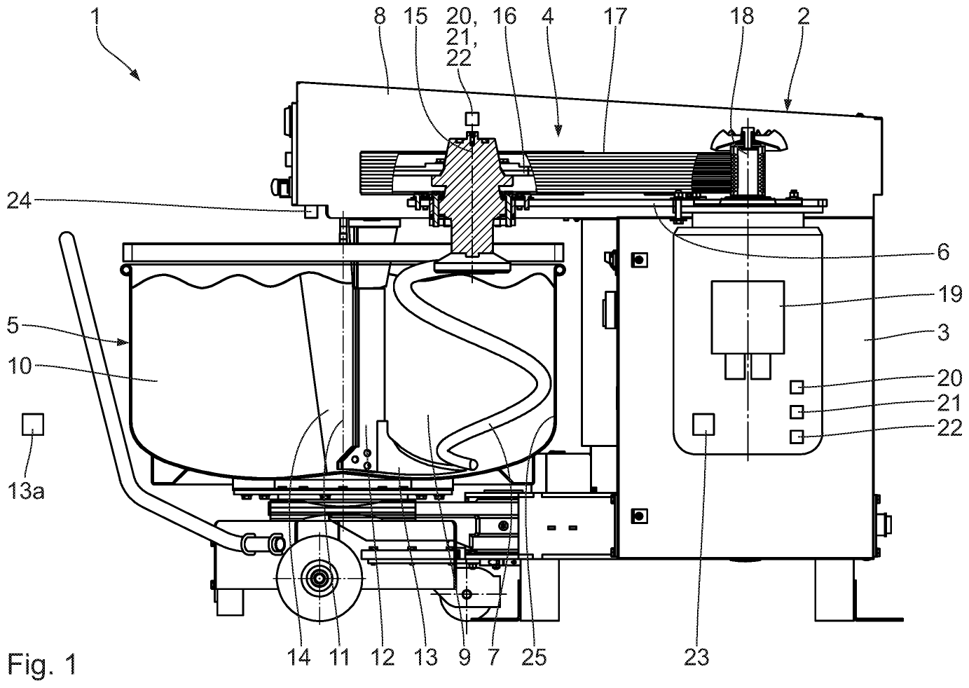

Based on FIGS. 1 to 3, a version of a processing device 1 for mixing and kneading dough, thus a dough-kneading device, is described in the following. The processing device 1 has a support frame within a machine housing 2 with a stand 3 and an arm 4. A tub 5 of the processing device 1 is used to accommodate the dough to be kneaded and mixed. The tub 5 represents a dough container.

A kneading tool 7 in the form of a vertical kneading spiral is mounted to a frame plate 6 of the support frame, which runs within the arm 4. In a working position, which is shown in FIG. 1, the kneading tool 7 protrudes into the tub 5 from above, starting from a head section 8 of the arm 4 overhanging the stand 3.

A volume within the rotating tub 5, which can be kneaded and mixed by the latter when operating the kneading tool 7, specifies a kneading zone 9. Outside the kneading zone 9, the dough to be kneaded and mixed is present in a resting zone 10. Between the kneading zone 9 and a vertical rotational symmetry axis 11 of the tub 5, a guide body 12 is arranged for guiding a movement of the dough in the tub 5. A Pt100-type temperature probe or temperature sensor 13 is attached to the guide body 12, which is in direct thermal contact with the dough in the tub 5. In addition, the dough-kneading device 1 has another temperature sensor 13a for determining a room temperature, at which the dough-kneading device 1 is operated.

Between the guide body 12 and the resting zone 10, a vertical air column 14 forms within the tub 5 during the operation of the processing device 1.

During operation of the processing device 1, the tub 5 is rotated in a motor-driven manner around the rotational symmetry axis 11 in a way that is known per se. Furthermore, the kneading tool 7 is driven in a motorized manner around a central and also vertically running kneading spiral axis 15, which runs so as to be spaced apart from the tub rotational symmetry axis 11. The spiral axis 15 simultaneously represents a kneading axis of rotation, around which the kneading tool 7 rotates during kneading. For this purpose, the kneading tool 7 is connected to a drive wheel 16 in a torque-proof manner. A drive belt 17 runs around a portion of the circumference of the drive wheel 16, via which the drive wheel 16 is connected to a drive shaft 18 of a kneading drive motor 19 in a non-positively locking manner. The kneading drive motor 19 represents a kneading tool drive of the dough-kneading device. The kneading drive motor 19 is also attached to the frame plate 6. The drive shaft 18 runs parallel to the spiral axis 15, thus also vertically. The drive wheel 16 and the drive belt 17 are housed in the arm 4 of the machine housing 2. The kneading drive motor 19 is housed in the stand 3 of the machine housing 2.

The dough-kneading device 1 also has a torque measuring unit 20 for the time-resolved measurement of a momentary torque acting on the kneading tool 7. The torque measuring unit 20 can work by measuring a current consumption of the kneading drive motor 19, which is in this instance designed as an electric motor. Alternatively, the momentary torque acting on the kneading tool 7 can also be detected by means of a separate measuring unit.

The dough-kneading device 1 also has a speed measuring unit 21 for the time-resolved measurement of a momentary speed, by means of which the kneading tool 7 rotates, and has a rotational position measuring unit 22 for the time-resolved measurement of a momentary rotational position of the kneading tool 7.

The measuring units 20 to 22 for the torque, the speed and the rotational position can also be arranged directly in the region of a bearing of the kneading tool 7, as is schematically indicated in FIG. 1. For example, the rotational position measuring unit 22 can be designed as a position encoder.

An analysis unit 23 of the dough-kneading device 1 is connected on a signal level to the torque measuring unit 20, the speed measuring unit 21 and the rotational position measuring unit 22. The analysis unit 23 is designed for the analysis of torque measurement results of the torque measuring unit 20. The analysis unit 23 is connected to the kneading drive motor 19 on a signal level.

The dough-kneading device 1 also has a level sensor 24 for determining a dough fill level in the dough container 5. For example, the level sensor 24 can be an optical sensor.

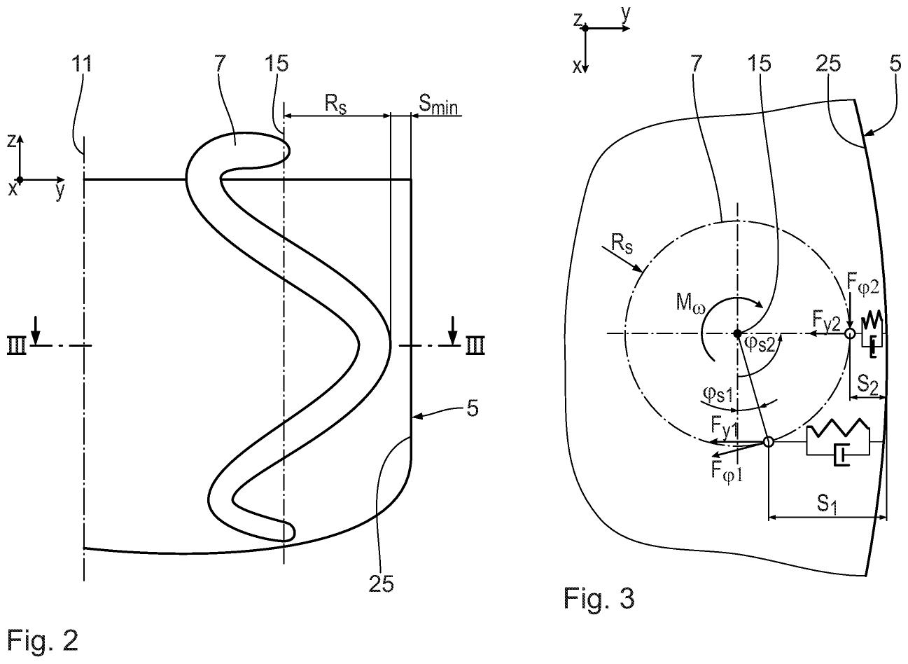

The kneading process exerted by the kneading tool 7 on the dough to be kneaded in the tub 5 can be understood by a modelling of the dough as a spring/damper element on an inner wall 25 of the tub 5. By establishing a corresponding system of differential equations, a fundamental oscillation and a first upper wave of a time progression of the momentary torque can be modelled. FIGS. 2 and 3 show relevant variables for this purpose.

R_{S} denotes a radius of the kneading tool 7 in the considered axis section, measured from the kneading angle axis 15. Sₘᵢₙ describes a minimum gap dimension between the kneading tool 7 and the tub inner wall 25 in the considered axis section of the kneading tool 7.

FIG. 2 shows forces F_{φ1}, F_{φ2}, which the dough exerts onto the kneading tool 7 in two angular positions φₛ₁, φₛ₂ of the kneading tool 7 in the considered axis section. Two gap dimensions S₁, S₂ between the kneading tool 7 in the considered axis section and the inner tub wall 25 belong to the two angular positions φₛ₁, φₛ₂. The forces exerted on the kneading tool 7 in these two positions φₛ₁, φₛ₂ have additional y-components F_{y1}, F_{y2} in addition to the tangential components F_{φ1}, F_{φ2}. Moreover, in FIG. 3, the torque M_{Ω} is once more drawn in schematically, wherein ω or ω_{S} represents the angular velocity of the kneading tool 7, thereby being a measurement for the rotational frequency of the kneading tool 7.

The differential equation describing the fundamental oscillation (angular velocity ω) and the first upper wave (angular velocity 2ω) of the torque M_{ω} contains a dough stiffness or dough elasticity c_{d} and a dough viscosity d_{d}, which can be determined over the entire kneading process. A unit of stiffness c_{d} is N/m. A unit of dough viscosity d_{d} is Ns/m.

The differential equation has the following form (φ=ωt, dφ/dt=ω):

M(t)=c_{d}R_{S}(sₘᵢₙ+R_{S})cos(ωt)−(c_{d}R_{S}²/2)sin(2 ωt)−(d_{d}R_{S}²/2)ω(cos(2 ωt)+1)

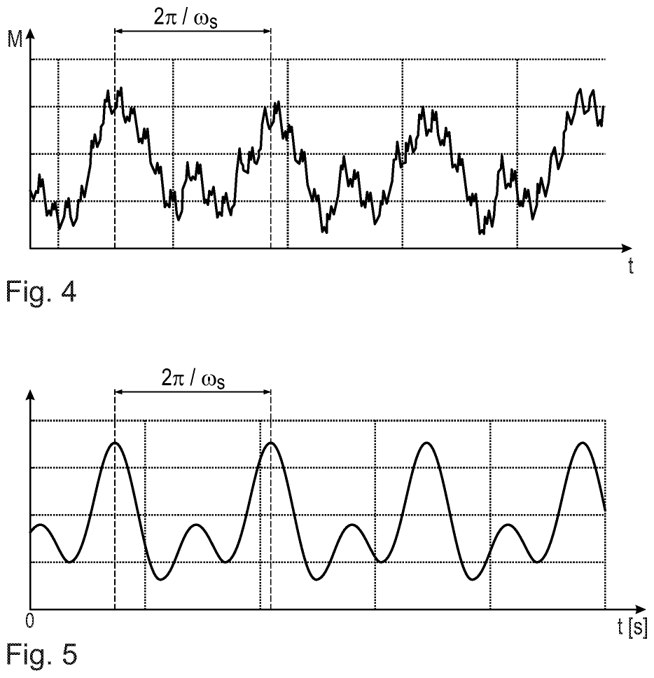

FIG. 4 schematically shows a measurement result of the temporal dependency of the torque M, which is exerted by the dough onto the kneading tool 7 and which is measured using the torque measuring unit 20.

FIG. 5 shows a model-like time progression of the torque M, which has been adapted to the measurement curve in accordance with FIG. 4 using appropriate fit parameters for the dough stiffness c_{d} and the dough viscosity d_{d}. This results in a periodic progression with a period of time T=2t/ωₛ which corresponds to the time period required by a full cycle of the kneading tool 7. This time period T can range between 0.1 s and 1 s and, for example, range between 0.15 and 0.45 s and, in particular, be within the range of 0.3 s.

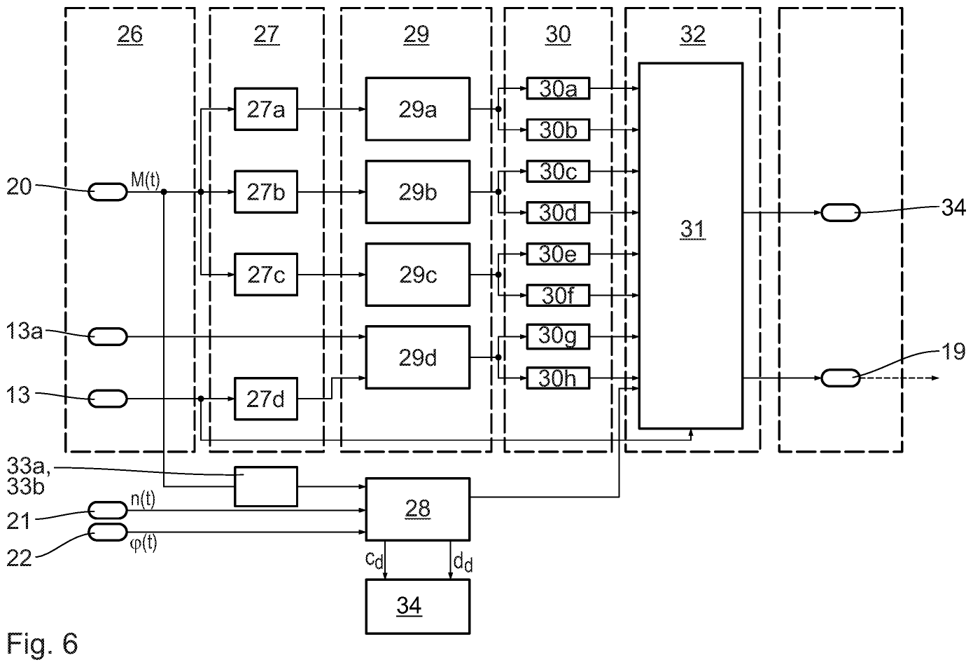

With the aid of this measurement data, as is explained on the basis of the flowchart according to FIG. 6, an expected kneading period until reaching a maximum torque M which, in the event of further operation of the dough-kneading device 7, acts on the kneading tool 1, is determined by means of the analysis unit 23. Furthermore, a dough elasticity or stiffness parameter and a dough viscosity parameter are determined from these measurement data measured in a time-resolved manner as actual dough parameters.

On the basis of FIG. 6, a method using this determination of the expected kneading period, as well as a method using the determination of the dough elasticity parameter and the dough viscosity parameter for operating the dough-kneading device 1 is described in the following.

During the kneading operation, a momentary torque M is determined in a measuring phase 26 using the torque measuring unit 20, which acts on the kneading tool 7 of the dough-kneading device 1. Furthermore, a momentary speed or an angular velocity ω of the kneading tool 7 is determined with the aid of the speed measuring unit 21 and a momentary rotational position φ of the kneading tool 7 is determined with the aid of the rotational position measuring unit 22.

Furthermore, in the measuring phase 26 of the kneading process, the room temperature is determined using the temperature sensor 13a and the dough temperature is determined using the temperature sensor 13.

The time-resolved measurement values of the torque and the dough temperature are then pre-filtered in a pre-filtering phase 27 using pre-filter algorithms 27a, 27b, 27c and 27d. The motor torque signal M(t) is pre-filtered in parallel via the three different pre-filter algorithms 27a, 27b, 27c. The still unfiltered measurement result of the motor torque M(t) is, in turn, transferred in parallel to an extended Kalman filter algorithm 28 parallel to the other determination algorithms, which, for its part, represents a determination algorithm. With the extended Kalman filter algorithm 28, a dough elasticity parameter and a dough viscosity parameter can also be determined as actual dough parameters from the time-resolved measurement values, as will be explained below.

The filter algorithm 28 is an extended Kalman filter. A theoretical description of such a filter can be found in: Dan Simon, Optimal State Estimation, Kalman, H. and Nonlinear Approaches, 2006.

In an extraction phase 29, an output signal of the pre-filter algorithm 27a is transferred to a first extraction algorithm 29a, which is designed as a type of floating mean value formation.

The data resulting from the further pre-filter algorithm 27b are transferred during the extraction phase to another extraction algorithm 29b, which is a Luenberger-filter algorithm, and which is executed as a disturbance variable observer. Such a Luenberger observer is described in: D. G. Luenberger: Observing the State of a Linear System, IEEE Transaction on Military Electronics, Volume 8, pp. 74-80, 1964.

The filter result of the further pre-filter algorithm 27c is transferred during the extraction phase 29 to another extraction algorithm 29c, which is a Kalman-filter algorithm. A theoretical description of a Kalman filter can be found in: R. E. Kalman: A New Approach to Linear Filtering and Prediction Problems, Journal of Basic Engineering, 35-45, 1960.

The unfiltered result of the room temperature measurement using the temperature sensor 13a, like the measurement result of the dough temperature filtered via the pre-filter algorithm 27d via the temperature sensor 13, is transferred during the extraction phase to another extraction algorithm 29d, which is also a Luenberger-filter algorithm.

The results of the parallel extraction algorithms 29a to 29d are subsequently in each case split and post-filtered in a post-filtering phase 30 in post-filtering algorithms 30a, 30b, 30c, 30e, 30f, 30g, 30h. These post-filtered results of the post-filtering algorithms 30a to 30h are then transferred to a monitoring algorithm 31. In the monitoring algorithm 31, the dough temperature reported by the temperature sensor 13 can also be included in an unfiltered manner as input.

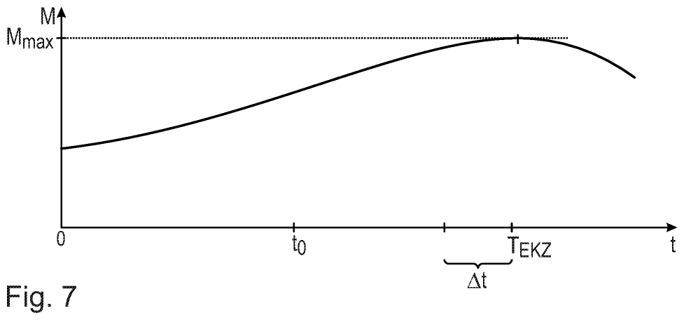

The various determination algorithms 29a to 29d and 28 produce independent results for an expected kneading period T_{EKZ} (cf. FIG. 7).

In a monitoring phase 32, the monitoring algorithm 31 monitors the criteria of the kneading operation, in particular, to what extent the determined expected kneading period has been reached.

In addition to the measured torque M(t), the speed n(t) and the rotational position φ(t), which are provided by the measuring units 20 to 22 still enter into the filter algorithm 28 working parallel to the above-described determination algorithms as input signals.

The unfiltered torque signal still passes through two bandpass filters 33a, 33b in parallel before entering the filter algorithm 28. A central frequency of the bandpass filter 33a can range between 3 and 4 Hertz (fundamental oscillation w). A central frequency of the other bandpass filter 33b can range between 7 and 8 Hertz (first upper wave 2w). The initially split measured signal running through both bandpass filters 33a, 33b is then re-merged into filter algorithm 28. In addition to the two bandpass filters 33a, 33b, in particular, in connection with the mixing phase, another bandpass filter can be used, which is not shown in the drawing and has a central frequency ranging between 1 and 2 Hertz (fundamental oscillation w in the mixing phase).

In the filter algorithm 28, a two-dimensional measuring vector is then formed initially from the filtered torque measurement signals for the two harmonic elements w and 2ω.

From the components of the measuring vector as well as the also measured speed n(t) and the rotational position s(t) as further components, a state vector with a total of seven components is determined. As part of the processing via the extended Kalman filter, a discretization is carried out in system functions coupled according to the seven states of the state vector. The filter algorithm 28 with the extended Kalman filter thus provides the actual dough parameters, elasticity or stiffness c_{d} and viscosity d_{d}, in addition to the other algorithms as part of a vibration analysis.

The first three components of the state vector correspond to the three terms of the above differential equation. Another two components of the state vector correspond to the dough stiffness c_{d}, as well as the dough viscosity d_{d}. Another two components of the state vector stand for a phase of the first harmonic oscillation w in relation to the rotating position φ of the kneading tool 7 and a phase between in each case the summands of the second harmonics 2ω in relation to the calculated position φ of the kneading tool 7 at twice the speed. This entire state function with a total of seven state functions is then subjected to the filter algorithm.

These actual dough parameters (c_{d}, d_{d}) determined by the filter algorithm 28 are output via a display element 34.

These actual dough parameters can then be compared with specified target dough parameters c_{d}^{S}, d_{d}^{S} for dough elasticity as well as dough viscosity, and the kneading operation can be controlled on the basis of the result of this comparison. In the comparison of the actual dough parameters with the specified target dough parameters, the determination of an actual value can be associated with a merit function. The merit function is a function of the actual dough parameters. The actual value of the merit function can then be compared with a specified target value of the merit function.

The output signal filtered by the filter algorithm 28 is then in turn transferred to the monitoring algorithm 31. On the one hand, the monitoring algorithm 31 outputs a signal “expected kneading period achieved” to the display element 34 and, on the other hand, it outputs a control signal to the kneading drive motor 19 for stopping the drive of the kneading tool 7 as soon as a predetermined kneading operating time is reached.

FIG. 7 shows the typical time progression of the torque M acting on the kneading tool 7 until reaching a maximum torque Mₘₐₓ.

The aim of the operating method is to interpret from an early time portion, for example up to a point in time t₀, measurement values that are sensorially detected during the operation of the dough-kneading device 1 in such a way that the expected kneading period T_{EKZ} can be determined until reaching a maximum torque M. Ideally, the point in time to from which the expected kneading period T_{EKZ} can be determined is very clearly before the end of this expected kneading period so that, for example, in the case of t₀=T_{EKZ}/2, the expected kneading period T_{EKZ} with a fault tolerance less than 10 percent, less than 5 percent, and more preferably, less than 1 percent can be determined with the operating method. For this purpose, the measurements, which regularly vary greatly during the kneading operation, are processed using certain algorithms and, in particular, are filtered and/or smoothed.

The kneading operation can be ended either exactly after the expiry of the determined kneading period T_{EKZ} or alternatively, a defined period of time Δt before or after the end of the determined kneading period T_{EKZ}. In this case, of course, the ending time must be after the determination time t₀.

The predetermined kneading service life can be precisely the kneading period determined with the aid of the above-explained operating method, thus the kneading period until reaching the maximum torque M.

Alternatively, by actuating the kneading drive motor 19 via the monitoring algorithm 31 of the kneading operation, a defined period of time before the expiry of the kneading period determined by the operating method can be ended.

Candidates for the expected kneading period emerge as parallel results of the post-filtered extraction algorithms 29a to 29d, each of which outputs for itself one such expected kneading-period candidate after post-filtering. Due to the split post-filtering, even for each of these extraction algorithms 29a to 29d, in each case two expected kneading-period candidates emerge as results of the post-filtering algorithms 30a to 30h. An additional candidate for the expected kneading period emerges as a result of the filter algorithm 28.

The filter algorithm 28 also outputs the dough stiffness c_{d} on the one hand and the dough viscosity d_{d} on the other hand as a dough property parameter. These dough parameters can also be fed to the display unit 34.

In determining the expected kneading period, that time-period candidate, which, within predetermined tolerance limits, was determined by a plurality of the parallel determination algorithms 29a to 29d, 28 can be accepted as a result. Such a majority determination is also referred to as democratic determination.

The dough level measurement via the level sensor 24 can also be included in the determination of the expected kneading period.

What is claimed is:

1. A method for operating a dough-kneading device, comprising the following steps:
time-resolved measurement of a momentary torque acting on a kneading tool of the dough-kneading device,
time-resolved measurement of a momentary speed of the kneading tool,
time-resolved measurement of a momentary rotational position of the kneading tool,
determining a dough elasticity parameter and a dough viscosity parameter as the actual dough parameters from the measurement values, and
outputting dough status data based on the measurement data and the determined actual dough parameters.

2. The method according to claim 1, further comprising the following steps:
comparing the actual dough parameters with specified target dough parameters,
controlling the kneading operation based on the result of the comparison.

3. The method according to claim 2, wherein, when comparing the actual dough parameters with the target dough parameters, the following steps are carried out:
determining an actual value of a merit function, with which the actual dough parameters are associated,
comparing the actual values of the merit function with a specified target value of the merit function.

4. A method for operating a dough-kneading device, comprising the following steps:
time-resolved measurement of a momentary torque acting on a kneading tool of the dough-kneading device,
time-resolved measurement of a momentary speed of the kneading tool,
time-resolved measurement of a momentary rotational position of the kneading tool,
determining an expected kneading period until reaching a maximum torque which, in the event of further operation of the dough-kneading device, acts on the kneading tool, based on the measured torque, the measured speed and the measured rotational position, and
ending a kneading operation for a currently kneaded batch of dough depending on the determined kneading period.

5. The method according to claim 4, wherein the kneading operation is ended exactly after the expiry of the determined kneading period.

6. The method according to claim 4, wherein the operation is ended following a defined period of time before the expiry of the determined kneading period.

7. The method according to claim 4, wherein at least two parallel determination algorithms are included in the determination of the expected kneading period.

8. The method according to claim 7, wherein, in determining the expected kneading period, as a result, that period which was determined by a plurality of the parallel determination algorithms is accepted.

9. The method according to claim 1, wherein a determination algorithm for determining at least one of the actual dough parameters and the expected kneading period uses a Kalman filter.

10. The method according to claim 1, wherein a determination algorithm for determining at least one of the actual dough parameters and the expected kneading period uses a floating mean value formation.

11. The method according to claim 1, wherein a temperature measurement is included in the determination of at least one of the comprising the actual dough parameters and the expected kneading period.

12. A dough-kneading device,
with a dough container,
with a kneading tool rotating within the dough container,
with a kneading tool drive,
with a torque measuring unit for time-resolved measurement of a momentary torque acting on the kneading tool,
with a speed measuring unit for time-resolved measurement of a momentary speed at which the kneading tool rotates,
with a rotational position measuring unit for time-resolved measurement of a momentary rotational position of the kneading tool, and
with an analysis unit connected to the torque measuring unit, the speed measuring unit and the rotational position measuring unit on a signal level for the analysis of torque measurement results of the measuring unit,
wherein the analysis unit is connected to the kneading tool drive on a signal level.

13. The dough-kneading device according to claim 12, comprising at least one temperature sensor.

14. The dough-kneading device according to claim 12, comprising a level sensor for determining a dough level in the dough container.
